(19) United States
(12) Patent Application Publication
(10) Pub. No.: US 2009/0005907 A1
(43) Pub. Date: Jan. 1, 2009

(54) Manipulator unit

(75) Inventor: Ami Kronenberg, Nesher (IL)

Correspondence Address: THE NATH LAW GROUP, 112 South West Street, Alexandria, VA, 22314, US

(73) Assignee: Orbital Robotics Ltd., Migdal HaEmek (IL)

(21) Appl. No.: 12/230,567

(22) Filed: Sep. 2, 2008

Related U.S. Application Data
(63) Continuation-in-part of application No. PCT/IL2008/000303, filed on Feb. 6, 2008.
(60) Provisional application No. 60/905,327, filed on Mar. 7, 2007.

(51) Int. Cl. B25J 13/00

(52) U.S. Cl. 700/248; 74/479.01; 700/245; 901/2; 901/43

(57) ABSTRACT

A manipulator add-on unit adapted for connection to a system designed for performing operations on a body having a central axis and a surface extending about said central axis, when mounted onto said surface and further adapted for performing rotary motion about said central axis, said manipulator add-on unit comprising a housing with a drive assembly, and a manipulator arm having a longitudinal axis and articulated to said drive assembly, wherein said housing is adapted for mounting onto said system, and said drive assembly is adapted for providing said manipulator arm with at least a reciprocal axial movement in the direction of said longitudinal axis.

### FIELD OF THE INVENTION

This invention relates to pipe-work machinery, in particular, for marking, cutting, welding of pipes etc.

### BACKGROUND OF THE INVENTION

Pipes are generally hollow tubular bodies generally having a central axis about which the body of the pipe is disposed, defining an axial direction thereof. Pipes are employed in a wide variety of fields and implementations such as water and sewage infrastructure, irrigation, industrial plants etc.

There is always a need to cut away or weld portions of the pipe for various purposes such as joining an additional pipe thereto (in alignment or in intersecting relation therewith), creating an opening for removal of material from the pipe etc.

The cut-away/weld may be of various geometric shapes ranging from straight cutting of the pipe perpendicular to the central axis thereof, to elaborate shapes such as for transition bodies, connecting of pipes of different shapes and sized etc.

Although most such a cut-away/weld is easily and accurately performed on a 3D model of the pipe on a computer, performing a desired cut-away/weld in reality tends to prove more elaborate due to the inaccuracy resulting both from manual marking of a cut-away/welding line as well as manually performing the cut-away/welding operations.

One type of devices suggested for performing the above operations are adapted to be mounted onto the pipe and perform a rotary motion about the central axis thereof so as to cut a portion of the pipe perpendicular to the central axis, such as disclosed in U.S. Pat. No. 5,227,601 etc.

Another type of devices further comprises an additional cutting assembly wherein the device is adapted to be mounted onto the pipe and while performing rotary motion about the central axis thereof, an operator may displace a part of the cutting assembly in the axial direction of the pipe to perform the desired cutting/welding operations. One example of such a device is disclosed in U.S. Pat. No. 5,159,756.

### SUMMARY OF THE INVENTION

According to one aspect of the present invention there is provided a manipulator unit adapted for connection to a system adapted for performing operations on a body having a central axis and a surface extending about said central axis, when mounted onto said surface and being rotated about said central axis, said manipulator add-on unit comprising a housing with a drive assembly, and a manipulator arm having a longitudinal axis and articulated to said drive assembly, wherein said housing is adapted for mounting onto said system, and said drive assembly is adapted for providing said manipulator arm with at least a reciprocal axial movement in the direction of said longitudinal axis.

Said system may comprise a drive unit adapted for imparting said system with rotary motion on said surface about said central axis when mounted onto said body. Said system may comprise a rotary arrangement for example a set of wheels adapted to come in contact with said surface in order to be displaced thereabout.

The body onto which said system is adapted to be mounted may be a solid body or a hollow body. In the former case, said surface is the external surface of the body and said system is adapted to be mounted thereon. Examples of such a body may be poles, tree trunks, etc. In the latter case, said surface may either be the external surface or the internal surface of said body, and said system is adapted to be mounted either onto said external surface or on said internal surface within the hollow body. Examples of hollow bodies may be pipes, tubes, chimneys etc.

Said closed cross-sectional contour may be of essentially round shape having a variety of possible shapes such as circular, oval, elliptic, or any other round shape, however devoid of significant negative radii along the circumference thereof. The term ‘negative radii’ refers to a mathematical definition concerning a contour in which the center of one or more of the circles, the arcs of which form the contour, is located outside the contour.

Said manipulator unit may be designed with an additional arrangement, allowing manipulator arm to perform rotary motion about the longitudinal axis thereof. Said manipulator arm may also be equipped with a manipulator module positioned at a desired location therealong and chosen for performing a desired operation on the body such as cutting, marking, welding, scanning etc. Said manipulator module may be designed so as to be pivoted about an auxiliary axis transverse to said manipulator arm.

As previously noted, said drive assembly may be adapted to impart to the manipulator arm both a reciprocal motion in an axial direction and rotary motion about the longitudinal axis of the manipulator arm, whereby the combined arrangement of rotary motion of the system about the surface of said body and the axial movement of the manipulator arm, along with pivotal motion of said manipulator module about said auxiliary axis may allow said manipulator module to reach any desired location on the external/internal surface of the body, depending on the manner of mounting the system thereto.

The drive assembly of said manipulator unit may be adapted to be connected to the drive unit of said system in order to draw power therefrom. Connection may be achieved by any known method.

Said manipulator unit may also be provided with a controller adapted for regulating the operation of both the manipulator unit and the system, i.e. the reciprocal axial movement and the rotary movement of said manipulator arm. Said controller may also be connected to said system in order to control the rotary motion thereof about said central axis. Said controller may also control the pivotal motion and operation of said manipulator module. Said controller may in turn be connected to a control center, which may be a lap top computer, a PDA device, a hand-held etc., and may be fully interfaced with a CAD/CAM software found on the lap top computer providing the controller with required data to operate the drive unit of the system and drive assembly of the manipulator unit.

When attaching the controller to an existing orbital system, calibration of the controller may be required. Such calibration provides that the controller derives proper information from orbital system and that the CAD/CAM software is properly interfaced therewith.

It is important to note that the location of the controller is not restricted to the manipulator unit and may also constitute part of the system. In such case, the manipulator unit may be adapted to be connected to the controller to receive information therefrom and be regulated thereby.

In assembly, the system is first mounted onto the surface of the body. Thereafter, the manipulator unit is mounted onto the system such that the longitudinal axis thereof corresponds to the central axis of the body. However, this is not necessarily the case as the manipulator unit may also be mounted onto the system such that its longitudinal axis is angled thereto.

Once mounted, the manipulator unit and system are connected to the controller which is in turn connected to the control center.

The following example refers to cutting a pipe, however, it should be understood that a variety of other operations may be performed by the system as indicated before, and further including painting, coating, corrosive treatment etc. For each of theses operations, a different manipulator module may be used.

Further in preparation, a desired program is loaded to the control center, e.g. laptop, the control center is then connected to the controller and an origin point for the operation is selected. Such a program may be, for example, a 3D model of pipe having a cut-away for connection of an intersecting pipe thereto. It should be pointed out that, unlike the complex and intricate production of such a cut-away in a manual fashion, producing the same on a 3D CAD/CAM software is a standard and simple operation.

At a final stage of preparation, a desired manipulator module is chosen and mounted onto the manipulator arm.

In operation, the controller receives from the control center the required data regarding the shape, size and orientation of the contour of the cut-away to be opened on the envelope of the pipe. Following this data, the controller will generate a signal to the system to perform a rotary motion about the pipe while simultaneously commanding the manipulator arm to reciprocate such that the manipulator module follows the exact contour as produced by the CAD/CAM software.

It should further be understood that once positioned at a desired location along the longitudinal axis of the body, the system is completely self-sufficient and controlled automatically by the control center, thereby eliminating the need for intervention of an operator.

In operation, occasionally, said system may slip on the surface of the pipe, i.e. a certain amount of slippage should be accounted for. This amount is not completely predictable and therefor feed-back about the real amount of motion is needed in operations that demand accuracy.

For this purpose, said system may further be provided with an encoder adapted to alert the controller of any such slippage and indicate the controller to take corrective action. Such an arrangement allows the controller to make sure that the manipulator module indeed follows the contour dictated by the CAD/CAM software.

As previously mentioned, said system may be adapted to perform additional operations, requiring different manipulator modules. Such operations may be any the following:

Marking—prior to performing a cutting operation using a system, a marking module may be mounted onto the manipulator arm and produce a marked outline of the cut-away to be cut or welded. Thereafter, said system may follow said marked outline. Alternatively, once marked, an operator may manually perform said cut-away;

Welding—two bodies may be welded to one another using a welding module in a manner similar to that described with respect to cutting; and

Scanning/inspecting—said manipulator module may be equipped with an optical arrangement (camera, X-Ray etc.) allowing scanning of the internal/external surface of the pipe.

According to a specific design, said system is designed such that the orientation thereof may be changed, i.e. such that the axis thereof is angled to the central axis of the body. Such an arrangement may provide the system with a spiral movement allowing it to progress along the body. Such a mode of operation may allow performing some of the following operations:

Painting/coating—said manipulator module may be a painting module provided with fluid connection with a paint storage, wherein during rotation of the system, the body, e.g. a pipe may be uniformly painted; and

Corrosive treatment—said manipulator module may be adapted for performing anti-corrosive operations, applying an anti-corrosive layer etc.

In such a configuration, the system may even be used for applications as specified below:
Bough trimming—The system may be mounted on a tree trunk and the manipulator arm may be fitted with an appropriate cutting module allowing the system to trim the boughs of a tree;
Spreading/Fertilizing—The system may be used with a spreading module attached to a storage of spreadable material;
Scraping/Cleaning—The system may be fitted with a scraper module adapted to clean the internal or external surface of a pipe; and
Picking—The system may be fitted with a storage compartment and said manipulator module may be a picking module adapted to remove material or items from locations along the body and displace them into said storage compartment.

Various variations of the manipulator unit and of the system may be employed as described below:
The manipulator module may also be equipped with a gravitational indicator providing information to the controller regarding the orientation of the manipulator unit and manipulator module. The controller may then be adapted to choose the appropriate operational mode for the manipulator module. For example, when working upside down, i.e. on the bottom side of a pipe, in case of welding, the operational parameters are different that those used when working on the top side of the pipe. Such parameters may be controller by the controller;
The manipulator drive assembly may be adapted to rotate the manipulator arm about the central axis thereof to change the orientation of the manipulator module, thus allowing it to perform operations at virtually any desired angle; and
The system may be fitted with more than one manipulator arm. This may be particularly useful in welding, wherein two counterpart manipulator arms may be used to provide a more balanced welding. In this case, the system optionally comprises more than one controller, wherein each controller is in charge of a different manipulator arm. According to a specific design variation, one of the controllers may be programmed to be a ‘master’ controller and the others to be ‘slave’ controllers;

According to another aspect of the present invention there is provided a system for mounting on a body having a central axis and a surface extending about said central axis in order to perform operations on said body, said system comprising a rotary arrangement providing for rotary displacement of said system upon said surface about said central axis, and a manipulator unit providing a manipulator arm thereof with axial displacement in the direction of said central axis.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A and 1B are schematic front and side views showing the geometry of a pipe and a system according to the present invention mounted thereon;

FIG. 2A is a schematic isometric view of one embodiment of the system shown in FIGS. 1A and 1B, when mounted onto a pipe;

FIG. 2B is a schematic isometric view of a manipulator mechanism used in the system shown in FIGS. 1A and 1B;

FIGS. 3A to 3C are schematic isometric, front and side views respectively of a pipe with a cut away produced by the system of the present invention; and

FIG. 4 is a schematic side view showing the basic geometry of the rotary arrangement of the system according to an embodiment of the present invention.

### DETAILED DESCRIPTION OF EMBODIMENTS

Geometric Configuration

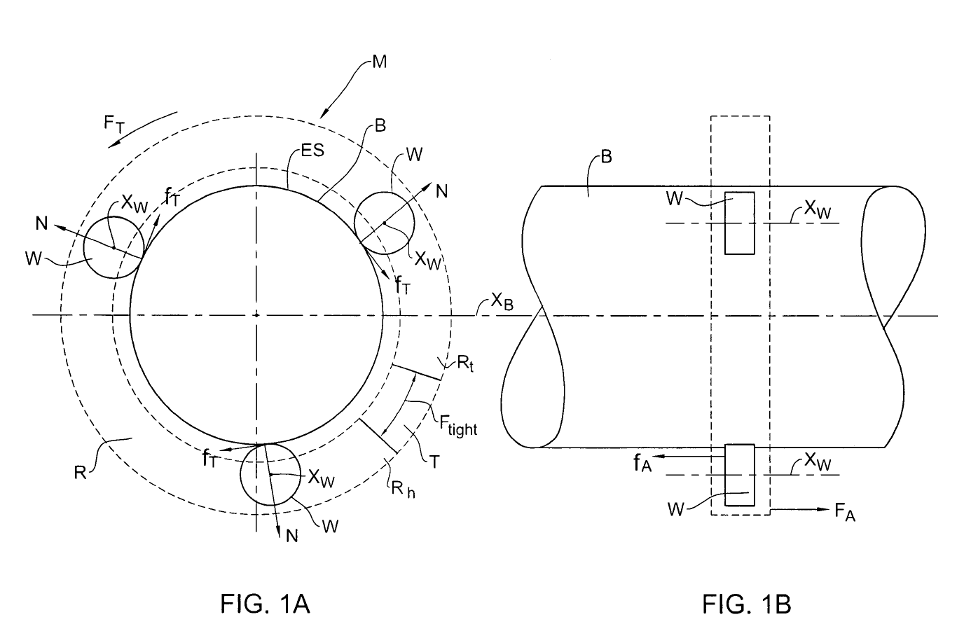

Turning to FIGS. 1A and 1B, a substantially cylindrical body generally designated B is shown having mounted thereon with a mechanism generally designated M comprising a ringed body R and three wheels W which are substantially equally angularly disposed, and are in contact with the external surface ES of the body B. The wheels W are arranges such that the axis of rotation thereof. X_{W} is essentially parallel to the longitudinal axis X_{B} of the body B. Uniform pressure is applied to the wheels W in a direction normal to the external surface ES so as to maintain contact with the external surface ES.

With particular reference to FIG. 1A, when rotating the mechanism M about the body B, a tangential force F_{T} is required to overcome tangential friction f_{T}. The friction f_{T} may be calculated by parameters like N, the normal force applied on the external surface ES by the wheels W and μ, the friction coefficient between the wheels W and the external surface ES. This coefficient depends on the materials out of which the wheels W and the external surface ES of the body B are made.

Turning to FIG. 1B, when trying to move the mechanism M along the longitudinal axis of the body B, an axial force F_{A} is required to overcome axial friction f_{A}. However, it should be appreciated that although μ remains the same, since the wheels W doesn't perform a rotary motion about the body B, the axial friction f_{A} requires much greater force F_{A} to perform the axial movement.

In the provided arrangement, during rotation about the body B, and provided no axial forces greater than F_{A} act on the mechanism, the mechanism M will remain in the same axial position with respect to the body B due to the friction force f_{A}.

Reverting to FIG. 1A, the ring R of the mechanism M is provided with a tightening unit T adapted to apply a tightening force F_{tight} by decreasing the distance between the head and tail ends Rₕ and Rₜ of the ring R respectively, thereby increasing the normal force N, and consequently the friction forces f_{T} and f_{A}. The ratio between the tightening force and the normal force depends on the amount of wheels W, for example, in case six wheels are used, on unit of tightening force F_{tight} yields and increase of six times the normal force N. This calculation is broadly based on the assumption that the wheels W are equally spaced about the perimeter of the body B.

It should also be emphasized that the above model is based on rolling action of the wheels W, in which case the static coefficient of friction is the dominant parameter. In special tasks in which the wheels are adapted to roll on bodies having a varying curvature, a high rate of slippage is expected. In such cases special care is taken to minimize the effects of dynamic coefficient of friction.

General Description of System Components

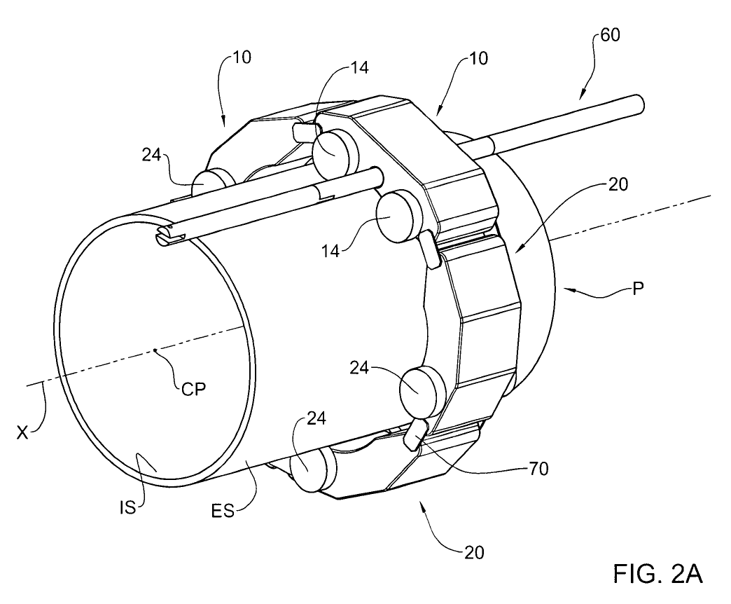

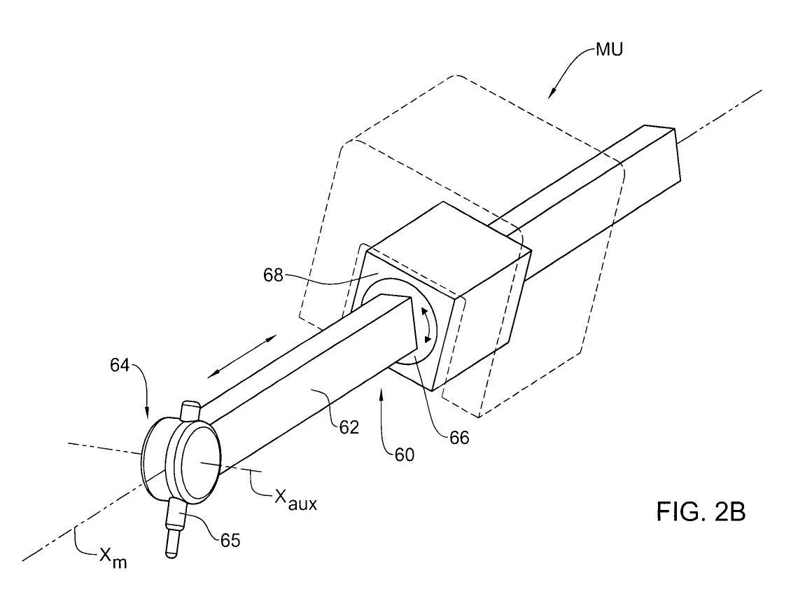

Turning now to FIGS. 2A and 2B, a system, generally designated 1 is shown comprising a drive unit 10, four link units 20, and a biasing arrangement 30, all interconnected therebetween to form a chain-like arrangement. The system 1 further comprises a manipulator unit MU adapted to perform operations on a body as will be described in detail later.

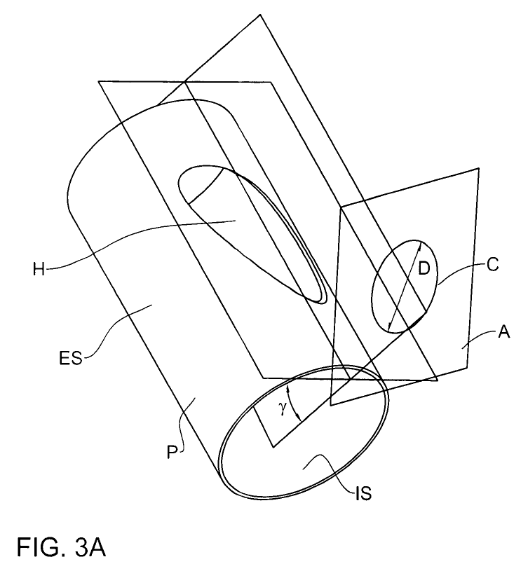

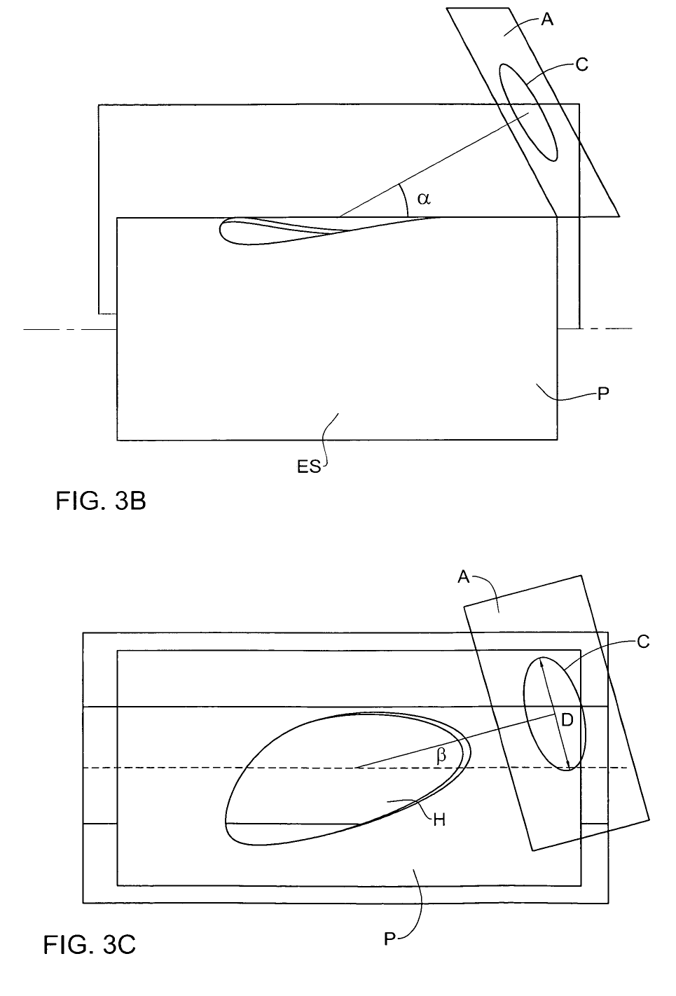

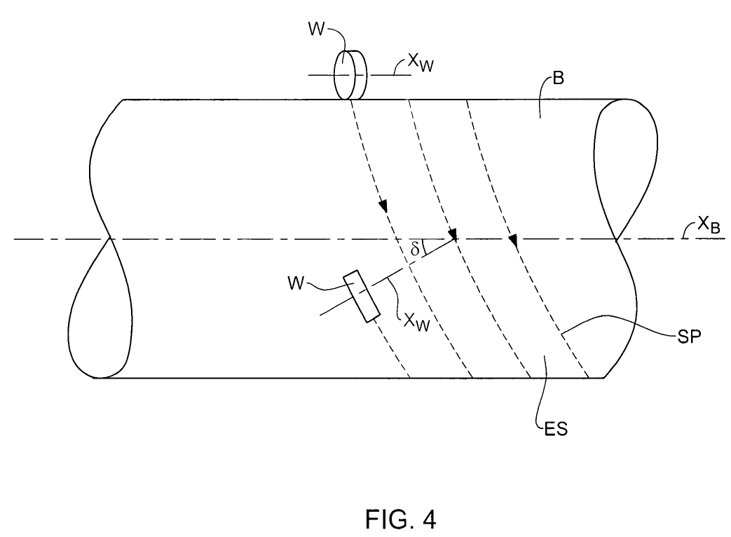

The drive unit 10 comprises a body 12 (shown FIG. 3A), two sets of two wheels 14 each, disposed at respective ends of the body 12, and two pairs of attachment ports 16 formed at the ends of the body 12, adapted to receive connecting elements 70 therethrough. The drive unit 10 further comprises a drive motor (not shown) articulated to the wheels 14 and adapted to provide them with a required drive. The drive unit 10 is further formed with a manipulator arm actuator port 18 defining an auxiliary axis Xa, and adapted to receive therethrough a manipulator arm 50 (shown FIG. 2B).

The system further comprises a biasing arrangement (not shown) designed to change its dimension so as to allow tight mounting of the system 1 onto the surface of the pipe P.

General Description of System Assembly

In assembly (FIGS. 2A and 2B), the drive unit 10 and a desired number of link units 20 are consecutively attached to one another to form a chain-like construction 2 having a lead end 2_{L} and a tail end 2_{T}. The number of units 10, 20 is determined according to the dimensions of the body onto which the system 1 is to be mounted. Each two adjacent units 10, 20 are pivotally articulated to one another by a connecting element 70 having a central axis, such that the attachment ports 16, 26 of each two adjacent units 10, 20 are aligned on a mutual pivot axis Xₚ.

As will be explained in detail later, the units are articulated to one another such that the torque generated by the drive unit 10 is transmitted to all the other link units 20, for example by means of a gear mechanism.

Thereafter, the biasing unit 31 is attached to the lead end 2_{L} and tail end 2_{T} of the chain-like construction 2 to form a closed loop. The biasing unit 31 provides regulation of the overall perimeter of the loop by its ability to change the length thereof. Therefore, when mounting the system 1 onto an external perimeter surface of a body, for example a pipe, the chain-like construction may be tightened around the pipe to provide the desired traction between the wheels 14, 24 of the units 10, 20 and the external surface ES of the pipe.

It should be appreciated that such an arrangement, when mounted on a body having a closed cross-sectional contour, for example, circular, oval, elliptic etc, provides that the entire system 1 is urged to dispose around a geometric center point CP. The center point CP however, may change its location due to the shape of the cross section.

After assembling the system 1, the drive unit 1 may be provided with the manipulator unit MU, and the manipulator arm 50 is fitted with a desired operation module 64.

Detailed Description of the Manipulator Unit

The manipulator unit, generally designated 60 is shown comprising a manipulator arm 62 fitted with a manipulator module 64. The manipulator arm 62 is received within an actuator 66 facilitating reciprocal displacement of the manipulator arm 62 along the longitudinal axis thereof. The actuator 66 in turn is housed within an actuator housing 68, adapted to rotate the actuator about the longitudinal axis Xₘ.

The manipulator module 64 is replaceable, and may be chosen from a wide variety of modules adapted for welding, cutting, marking, scanning etc. The manipulator module 64 itself comprises an auxiliary arm 65 adapted to perform a rotary motion about an auxiliary axis Xₐᵤₓ.

In assembly, the actuator housing 68 is mounted onto one of the link units 10 and is connected to the drive assembly (not shown) which is responsible for both the reciprocal and rotary motion of the manipulator arm 62.

Thus, in operation, the tip of the auxiliary arm 65, which may be, for example, a plasma cutting head, is capable of selectively reaching any desired location and angle on the pipe.

Preparation

Turning now to FIG. 8, when the system 1 is to be used to perform a desired operation on a pipe P, the system 1 is first mounted onto the pipe P at a desired location and the biasing arrangement 30 is used to tighten the system 1 about the pipe P. In this position all the wheels 14, 24 of the drive unit 10 and the link unit 20 respectively come in surface contact with the external surface ES of the pipe and the system 1 is considered to be secured to the pipe P. The term ‘secured’ should also be understood such that the system 1 is tensioned on the pipe P so as to prevent disengagement therefrom even if the pipe P is brought to a vertical position.

The desired location is determined as an initial point referring to coordinates of the body set by an operator to thereby define an origin point, i.e. origin coordinates.

It should also be noted that a tightening to traction ratio λ may be defined denoting the change in traction force (F_{Trac}) resulting from compression of the spring by a unit force (F_{Comp}), i.e.

$$λ = \frac{{F}_{Comp}}{{F}_{Trac}} .$$

Thereafter, a desired manipulator module 64 is fitted to the manipulator arm 62, according to the desired operation.

At a final stage of preparation, the drive unit of the system, drive assembly of the manipulator unit MU and the manipulator module 64 are connected to a power source and the controller, and the controller is connected to the control center.

General Operation

Tuning now to FIGS. 3A to 3C, in operation, the system 1 may perform a number of operations including cutting, welding, marking and scanning. For each of the listed operations a different manipulator module 64 may be employed.

The operation of cutting a cut-away H in a pipe P is described.

The pipe P is to be formed with a cut-away H in order to prepare the pipe P for welding thereto of an additional pipe connecting thereto. The additional pipe has a circular cross-section C of diameter D, and is inclined with respect to the pipe P an angle α with respect to the vertical plane and an angle β with respect to the horizontal plane. More particularly, the central axis of the additional pipe lies on a plane which is angled at γ to a horizontal plane tangent to the surface ES of the pipe P. As is apparent from FIGS. 3A to 3C, the shape of the cut-away H is of unique geometric shape and dimensions derived from the size and inclination of the additional pipe.

In order to cut the cut-away along the exact required contour, the manipulator module 64 is required to perform motion in both the axial and circumferential directions. Axial movement is provided by the drive assembly of the manipulator unit MU displacing the manipulator arm 62 within the actuator 66, while circumferential movement is provided by the entire system 1 rotating about the pipe P.

Both the drive unit responsible for rotation and the drive assembly responsible for axial displacement of the manipulator arm are controlled by the control unit, which in fully interfaced with the control center and a 3D software providing the exact special shape and orientation of the cut-away contour.

It should be understood that once the system 1 is positioned at the desired location and connected to the control center, it is completely and independently operative eliminating the need for intervention of an operator.

Ideally, the biasing unit 30 is tensioned to such an extent so as to provide that the wheels of the units have enough traction on the external surface of the pipe in order to roll thereon without slippage. However, in order to provide that the desired contour is cut out regardless of slippage, the controller is provided with an encoder following a mark on the external surface of the pipe. The encoder is adapted to inform the control unit in case of slippage, wherein the control unit is adapted to respond by correspondingly changing the circumferential and axial displacement to maintain proper cutting of the contour of the cut-away. The encoder may be optic based, laser based etc. The system also provided with an auxiliary wheel to follow the surface of the pipe P together with the system 1.

Progression Along the Pipe

Turning now to FIG. 11, the system 1 is shown with a design allowing the wheels 14, 24 to assume a position in which the central axis X_{w} thereof is angled at δ to the longitudinal axis of the pipe P. Under such an arrangement, rotary motion of the system 1 about the pipe P will entail progression of the system 1 along the pipe P in a spiral path SP.

Such a mode of operation may be particularly useful for operations concerned with maintenance of the entire pipe P, for example painting, anti-corrosive treatment, polishing, coating etc.

Thus, the manipulator arm 62 may be fitted with an appropriate manipulator module 64, for example, a painting module, and progress along the length of the pipe while spraying paint either on the internal surface IS or the external surface ES, depending on the manner of mounting of the system 1 onto the pipe.

It should also be noted that the design of the system is such that provides that the progression is gradual and uniform along the pipe P, allowing application of a uniform layer of paint on the internal or external surface.

Those skilled in the art to which this invention pertains will readily appreciate that numerous changes, variations, and modification can be made without departing from the scope of the invention, mutatis mutandis.

1. A manipulator unit adapted for connection to a system designed for performing operations on a body having a central axis and a surface extending about said central axis, when mounted onto said surface and further adapted for performing rotary motion about said central axis, said manipulator unit comprising a housing with a drive assembly, and a manipulator arm having a longitudinal axis and articulated to said drive assembly, wherein said housing is adapted for mounting onto said system, and said drive assembly is adapted for providing said manipulator arm with at least a reciprocal axial movement along a direction generally parallel to said longitudinal axis.

2. A manipulator unit according to claim 1, wherein said manipulator unit is adapted to be equipped with a manipulator module for performing said operations.

3. A manipulator unit according to claim 1, wherein the system comprises a rotary arrangement providing for rotary displacement of said system upon said surface about said central axis.

4. A manipulator unit according to claim 1, wherein the manipulator unit is adapted for performing at least one of the following: marking, cutting, welding, inspecting, scanning, painting, and coating.

5. A manipulator unit according to claim 1, wherein the body is a solid body having an external surface.

6. A manipulator unit according to claim 1, wherein the body is a hollow body having an external and an internal surface.

7. A manipulator unit according to claim 1, wherein said manipulator unit is provided with a controller adapted for regulating the operation thereof.

8. A manipulator unit according to claim 7, wherein the controller is also adapted for regulation of rotary motion of the system about said body.

9. A manipulator unit according to claim 7, wherein said controller is also adapted for controlling the operation of said manipulator module.

10. A manipulator unit according to claim 9, wherein the manipulator unit is equipped with a gravitational indicator providing information to the controller regarding the orientation of the manipulator module.

11. A manipulator unit according to claim 10, wherein said controller is adapted to determine the appropriate operational mode of the manipulator module based on said orientation.

12. A manipulator unit according to claim 7, wherein the controller is connected to a control center providing data regarding a desired operation.

13. A manipulator unit according to claim 12, wherein the control center is provided with a CAD/CAM software, and the controller is fully interfaced therewith.

14. A manipulator unit according to claim 1, wherein said manipulator unit is sufficiently light so as to be portable by a single operator.

15. A manipulator unit according to claim 1, wherein, when mounted onto the body, the system is adapted for aligning itself to become perpendicular to the longitudinal axis.

16. A manipulator unit according to claim 7, wherein said manipulator unit is further provided with an encoder adapted to alert the controller of slippage of the system along the surface and indicate the controller to take corrective action.

17. A manipulator unit according to claim 16, wherein the encoder is optic based.

18. A manipulator unit according to claim 1, wherein, when the system further comprises rolling members adapted to engage the surface of the body, and wherein when said system is mounted onto said body, said rolling members are arranged such that the axis of rotation thereof is inclined with respect to the longitudinal axis, whereby rotary motion of said system about said body entails axial displacement of said system along the central axis of said body.

19. A manipulator unit according to claim 18, wherein said manipulator unit and system are used for performing the operations of painting, coating, scanning and corrosive treatment.

20. A manipulator unit according to claim 1, wherein the system is adapted to be mounted on the internal surface of said body.

21. A manipulator unit according to claim 1, wherein the system comprises a plurality of drive units.

22. A manipulator unit according to claim 7, wherein said controller is adapted at to function as a master controller for a number of slave controllers of additional manipulator units.

23. A manipulator unit according to claim 7, wherein said drive assembly is a servo motor, operation of which is coordinated by the controller.
